(19) United States
(12) Patent Application Publication
(10) Pub. No.: US 2015/0024107 A1
(43) Pub. Date: Jan. 22, 2015

(54) Waffle Irons and Waffle-Based End Products

(71) Applicant: Julian's Recipe LLC, Montgomery, NY (US)

(72) Inventor: Alexander Dzieduszycki, New York, NY (US)

(73) Assignee: Julian's Recipe LLC, Montgomery, NY (US)

(21) Appl. No.: 13/946,157

(22) Filed: Jul. 19, 2013

(51) Int. Cl. A21B 5/02; A21D 8/06

(52) U.S. Cl. CPC A21B 5/02; A21D 8/06
USPC 426/549; 99/372; 426/496; 99/373

(57) ABSTRACT

A waffle iron comprising a set of patterned recesses for use in a conventional waffle oven for a food production plant. The waffle irons are precisely formed with reduced recesses to produce a waffle having reduced depth of recesses and increased thickness in the center of the waffle to allow the same to be easily, economically, and without crumbling, sliced in to halves by a commercial bakery, bread or bagel slicer, producing matching halves, each of which has a patterned surface and an opposed flat surface. A new waffle-like end food product is provided for use in making sandwiches.

### BACKGROUND OF THE INVENTION

The present invention relates to waffle irons, intended to be primarily used in a commercial food manufacturing plant or factory although, of course, the invention and the waffle irons disclosed herein can also be suitably modified and incorporated into a home use version of a waffle maker. The present invention relates to a set of waffle irons which when installed into a waffle oven or waffle maker and appropriately heated, filled with batter (any recipe can be used but, of course, some waffle recipes are more desirable than others and, indeed, the preferred embodiment of the present invention uses yeast risen dough which is not batter, although for present purposes the term “batter” is all inclusive of the variety of recipes of the ingredients for making a waffle) and then let to heat and “bake”—the batter provide a new end product—a waffle which is then, by its precise dimensions, capable of being sliced, preferably by a commercial bread slicing machine, into opposed pairs of waffle pieces, one side displaying the waffle pattern, the other side being flat. Each slice, about ½ of the original overall waffle's thickness, can be used to create another new food product—i.e., the slices can be used for a breakfast sandwich (with bacon, ham and egg therebetween); for lunch (for example, a beef burger, turkey burger, a cheese burger, etc.) or a grilled waffle sandwich (cheese between the slices). Many variations of uses of the new end product can be easily appreciated by those of skill in the art. The invention relates to the waffle irons and the end product first formed by the use of the waffle irons as well as the secondary end product created by a slicing of the waffle into opposed halves. The opposed pair or minor slices from a single waffle can be consumed by themselves as a treat; as a meal, used for a sandwich, as a bun, etc., whether consumed for snack, a breakfast, lunch, dinner or dessert sandwich.

According to the preferred embodiment of the invention, a complete set of waffle irons will be installed onto a waffle-making oven in a commercial food or waffle production facility.

A dough divider and a proofing chamber will desirably be located upstream of the waffle oven. The output of the waffle oven, full waffles, both sides of which are with the waffle pattern, travel on a conveyor belt or other mechanical system to a cooling area where the waffles are sliced and then packaged. The end products, the waffle slices, are capable of being “loaded” with other food compositions, e.g., cheese, turkey, burger meat, etc. The resulting sandwich (or plain if not made into sandwiches) is then frozen and bulk packaged for transportation and sale to consumers in food stores, grocery stores, restaurants, fast-food restaurants, in homes, etc. The consumer can simply re-heat the product, within or out of the plastic packaging (within only if a microwave reheating is performed) and consumed.

The waffle irons disclosed herein are precisely machined, designed and manufactured to enable the same to be installed upon standard commercial waffle-making machines in a large scale waffle making production line. After the waffles (from the oven) are cooled, first created by use of the present waffle irons in a waffle oven, the waffles are sliced by a conventional bread-slicing machine. The invention relates to creating a waffle slice with at least one surface having the waffle pattern which can be sliced by generally commercially available bread or bagel slicers to produce two opposed and minor-like halves of the waffle which, together, form the matching ends of a food sandwich. The two slices are perfect matches for one another as they are formed from the same original thickness waffle, formed from the inventive waffle irons disclosed herein.

Thus, the present invention relates to a set of opposed waffle irons for use in a commercial bakery or food manufacturing plant. Appropriate batter is introduced into the waffle oven, between the waffle irons. Generally, the batter comprises suitable amounts of flour, sugar, butter, water, yeast, eggs, etc. (any suitable recipe can be used but, of course, some are preferred in comparison to others, depending upon taste, cost, available ingredients, desired shelf life, end use, etc.). The waffle irons are pre-heated, batter applied to one surface and then the opposed waffle iron closed thereover with the batter therebetween. Alternatively, the waffle irons can be initially closed together and batter injected or otherwise introduced therebetween, similar to a simple injection molding process. In any event, with batter between the opposed waffle irons, the irons are maintained at a precise temperature, for a predetermined time, and then separated, with the waffle food product being thus formed. Gravity, a mechanical fork, or another mechanism can separate the “baked” waffle from the opposed waffle irons. The waffle is then cooled, sliced, and made (or not) into a sandwich, before packaging.

According to the present invention, the waffle formed by the waffle oven is conveyed to a commercial slicing apparatus, similar to that used for slicing of bread, bagels, etc., and the single waffle becomes a new and highly useful end product, a pair of perfectly matched waffle halves. These can be packaged, transported and sold to consumers. The halves can be eaten alone, formed into a simple waffle sandwich with some food between the halves. The halves can be used as opposed ends to a sandwich, a breakfast sandwich, a lunch sandwich, dinner, a dessert (ice cream between the halves), etc.

### DESCRIPTION OF THE PRIOR ART

Waffles have been a favorite food product for many years. There are many varieties of waffles, some flavored, e.g., chocolate flavored waffles, vanilla, ice cream, whipped cream, maple syrup, powdered sugar, some today with blueberries and Greek yogurt, bananas, etc. Some of the waffles have the flavors/ingredients mixed into the batter, some waffles are formed just from the batter and the ingredients and flavorings added atop the waffles. Freshly made, waffles, whether made from simple recipes or today's more popular Liege waffles (originated in Belgium) they are enjoyably consumed, considered delicious, and are served for breakfast, lunch, dinner, dessert, brunch, snack etc. Waffles are, generally speaking, a food product formed by a mixed recipe of batter which is fried or baked between a pair of highly heated waffle irons which produce a distinctive pattern of connected-together, square shaped depressions surrounded by upwardly projecting outer walls surrounding the depressions. Of course, other shapes for the depressions, the walls, and the perimeter of the waffle have been used in the past.

Conventional waffles whether commercially formed by large scale baking facilities or in a restaurant, at a diner, even in one's home, generally have both sides of the waffle having the distinctive waffle pattern—depressions surrounded by upwardly extending yet interconnected walls. There has not been, to the inventor's knowledge, a waffle made and sold which comprises only a single flat surface on one side and a waffle pattern on the other. Relatedly, there has not been made nor sold, to the inventor's knowledge, a matched pair of halves of a waffle which can be used to form a sandwich wherein the waffles halves have one side flat and the other or outer sides with the waffle pattern. The present invention provides the waffle irons for forming such a waffle which, when sliced, produces a set of matched waffle halves having one side flat (yet baked or fried batter) and the other (or outside) surface of the halves having the distinctive waffle pattern.

Sandwiches are a perennial food favorite, too. Generally, sandwiches are formed from either sliced bread (white, whole wheat, rye, pumpernickel, etc.) or from a roll or other dough yet baked product which is sliced to provide a pair of opposing flat surfaces and the outside surfaces being flat or having surface contour (e.g., a Kaiser roll; a dinner roll; a croissant; etc.). These dough-based products have been used for years to produce delicious sandwiches, for breakfast, lunch, dinner, snack, etc. They do not, however, provide the texture, taste, nor look of a waffle on the outside with a flat surface facing another flat surface such that sandwich material can be easily piled therebetween. The present invention provides a food product for use in sandwich making wherein the two substrates for the sandwich have waffle patterns, the inside and opposed surfaces are flat for accepting the piled-on food, and the sandwich halves are mirror images of one another. This allows the sandwich to be substantially uniform in thickness and provides a highly visually pleasing end product.

Pancakes, wraps, fajitas, etc. have also been available and used for forming food products.

These articles, combined with other food, e.g., turkey, chicken, salad greens, peppers, onions, etc. can be formed to produce a sandwich-like end product. However, the end product does not have the taste, texture, or the aesthetic look of a waffle, with pattern on the outside and, yet, with flat inwardly directed and opposed surfaces, each of which minors the image of the opposed substrate as the two were once a single waffle, before separation by slicing. The present invention represents a significant advance over the prior art.

Waffles have been provided to various categories of consumers for reheating and consumption. For example, frozen waffles are generally now available in neighborhood or “big box” grocery stores (Giant; Harris Teeter; Stop & Shop; Costco; Sam's Club, etc.). The consumer is expected to buy the packaged product (usually 4 or more to a box) and maintain the same in their home freezer until desirably reheated. Some waffles can be reheated after removal from their individual cellophane wrappers and placed into a microwave; some reheated within their wrappers within the microwave; some are removed from the wrappers and placed into a toaster; some heated in a skillet, on a frying pan, some, even, on a stick at a cookout! Relatedly, some frozen waffles are purchased by restaurants, diners, fast food establishments, and made in their ovens, frying pans, toasters, etc. and then served to consumers. Supplying frozen waffles to consumers (whether for individual consumption or for selling to ultimate consumers) is big business and commercial bakery-like factories and waffle production facilities have sprouted up throughout the United States.

A waffle making facility generally includes a batter forming area for mixing the raw ingredients of the recipe, a dough dividing section and proofing section for the dough sections, and a waffle oven. The waffle oven generally has one or more sets of opposed waffle irons which are heated for making waffles. The waffle irons have opposed waffle patterned surfaces and it is between those waffle irons of the conventional waffle production process that conventional waffles are formed. Generally, the waffle production process is highly automated and the waffle irons are moved within a longitudinal oven (maintaining a gradient of heat at a determined baking or forming temperature) until the waffle is formed. At the end of the waffle oven, the waffle irons are separated and the waffle formed therebetween is dropped onto a conveyor belt which the waffle is carried for cooling, packaging and then cardboard packaging, then onto pallets for transportation to stores and restaurants.

According to the present invention, the waffle irons are precisely machined and structured so that the waffle so formed therebetween, within a conventional waffle oven, has a middle section of a precise dimension and, correspondingly, the distance between the outside surfaces of the waffle so formed, is precisely determined, so that the cooled waffle can be fed into a conventional slicing machine. There, the waffle, formed between the opposed heated surfaces of the inventive waffle irons, can be sliced, in half, with each half thus comprised of a minor-image to its opposing half, having a patterned outside surface of a waffle, and a flat surface (formed by the slicing action cutting through the center of the thickened waffle originally formed). This new product can then be individually packaged in cellophane, if desired, packaged in groups of one, two, four, eight, for example, into a cardboard box, then in master cartons, then onto pallets, etc. for transportation, in frozen form, to the restaurant, food store, diner, etc. for ultimate reheating and consumption by an eating consumer.

The prior art does not teach nor suggest any waffle irons nor waffle end product which provides a pair of opposed and mirrored image matching waffle halves, formed with a single flat and facing surfaces and a pair of outwardly directed, waffle patterned surfaces. This new invention—the waffle irons to be used in conventional waffle ovens, which produce a waffle which is then sliceable into matching halves (one side flat—one side waffle patterned) by a conventional and commercially available bread slicer in large scale food and bread manufacturing facilities, produces a new, useful, delicious and highly versatile food product.

Various shapes and sizes of waffles, pancakes, crepes, breads, etc. have been made in the past. The present invention is not necessarily limited to a round waffle (perimeter is round) but, could, of course, extend to waffles which are square in perimeter, oval, hexagonal, Mickey Mouse-shaped in profile, etc.

### SUMMARY OF THE INVENTION

The present invention comprises at least a pair of opposed waffle irons which can be installed and mounted into commercially available, large scale waffle production facilities comprising waffle ovens. Alternatively, of course, the present invention can be simplified and downscaled in size to provide a pair of opposed waffle irons which can be used with a simple, at-home waffle making skillet-like device, the type which “turn out” a single waffle at a time. The opposed waffle irons, however, are precisely formed and, yet, as mentioned, are easily compatible with the available waffle ovens so that they can be used with the present new waffle irons. However, to accomplish the end goal of producing a waffle which can then be sliced in half, with minimal crumbling, with mirror or matching halves, by a conventional bread slicing machine, also available in commercial bakeries and large scale bakery facilities, the depth of the recesses of the waffle pattern have been reduced and the thickness in the middle increased. This inventive approach provides the desired end product, a pair of matched waffle halves, each having a flat face and a waffle pattern.

The thickness of the overall waffle, determined by the waffle irons and the increased thickness in the middle of the formed waffle, while the depth of the recesses has been reduced (to maintain the quantity (in volume or weight) of batter per waffle) have been precisely derived so that the waffle, when formed, cooled and then cut in half, presents two outwardly extending, opposed waffle patterned surfaces and yet, the middle, cut by a conventional commercially available bread-like slicing machine, can slit the same without crumbling of the waffle. Thus, the center, cut by the slicing machine, presents two opposed, minor imaged, flat surfaces for use in sandwiches, buns, etc. The waffle irons allow for proper pressure cooking (because of the waffle irons being maintained in a compressive condition with respect to their heated surfaces) of the dough providing a proper consistency and color/texture, and, of course, taste. After cooking the batter/dough to form the waffle (with the increased center dimension and the decreased depth of the recesses in the waffle pattern) the waffle is cooled and passed to a slicing machine for splitting the waffle. The center thickness of between about 10 to 20 mm, preferably about 11 to 15 mm, after splitting, is not too thick, such that there is too much dough/waffle and, yet, not too small so that slicing is difficult or leads to crumbling. The waffle can be sliced by the conventional, available, commercial slicing machinery, already present in bread, bagel and baking factories. The overall thickness of the finished product in certain sections, pre sliced is 2 mm. To accomplish this uniform thickness and the central thickness, as indicated, while maintaining an overall weight of about 55 to 60 grams per full waffle, a suitable size for nutritional, sandwich size, caloric intake, pricing, etc. the thickness, pre slicing, is the range of about 10 to 20 mm, but preferably about 11 to 15 mm. This was accomplished by the inventor's ingenuity in reducing the depth of the waffle's shaped recesses. The new waffle irons, so configured and designed, allow for excellent throughput of about 3,000 units per hour on a conventional waffle oven and conveyor system, with batch mixing of ingredients. Indeed, the present invention can lead to rates of about 9,000 to 20,000 per hour of waffles as the time for baking a set of waffles between the irons is generally less than about 3 minutes, more specifically, only about 2 minutes and 45 seconds.

### BRIEF DESCRIPTION OF THE DRAWINGS

FIG. 1a is a top, plan view of the waffle iron or plate made according to the present invention, the same being installable onto a waffle oven of a conventional and commercial type, as shown in FIG. 3;

FIG. 1b is a side, view of the waffle irons, and serves to illustrate that when the bottom waffle iron is superimposed by an identical top-located waffle iron, a chamber is defined therebetween for the batter for forming a new waffle, according to the present invention;

FIG. 1c is a side view of the profile of the waffle iron shown in Figure la, clearly showing the bottom surfaces of the substantially square recesses, the upwardly inclined walls between the recesses, and the level, connecting tops of adjacent inclined walls for the waffle iron shown in FIG. 1a;

FIG. 2 is a schematic view of a dough divider and a proofing chamber in a high volume, waffle production facility;

FIG. 3 is a schematic and representative perspective end view of a conventional high volume, waffle oven used in a waffle production facility;

FIG. 4 is an enlarged end perspective view of the waffle oven and shows the inventive waffle irons installed thereon;

FIG. 5 is a partial rear perspective view of the cooling conveyor system of a conventional high volume, waffle cooling system, a component of a waffle production facility;

FIG. 6 is an enlarged end view of the now-baked waffles, as they pass out of the end of the waffle oven (the upper-located waffle irons are shown at the top of the Figure) as the waffles, now properly baked, are shown extending across the waffle oven after the top set of waffle irons have become disengaged or separated from the corresponding bottom waffle irons, thereby exposing one surface of the waffles to the air and just before the waffles fall, by gravity and with an pneumatic assist, onto the cooling conveyor, partially shown below;

FIG. 7 is a top, rear perspective and enlarged view of the completely baked waffles, exiting from the waffle oven, as they are conveyed to the cooling area, prior to slicing in a conventional bakery, bread or bagel slicing machine. For illustrative purposes, the waffles shown herein are traditional vanilla-flavored waffles each of about 55 grams in weight;

FIG. 8, a-c, are perspective and enlarged views of three food products (cheeseburger; breakfast sandwich made of two slices of cheese, egg, and ham; and a simple ham sandwich, respectively) with FIG. 8a formed from slicing the waffle into halves which waffle was formed by the new waffle irons and the mechanisms of FIGS. 1-6; and

FIG. 9 is a front perspective view of completely baked, snack-sized waffles of the present invention, having been baked in the oven shown in FIGS. 2-7.

### DETAILED DESCRIPTION OF THE DRAWINGS AND THE PREFERRED EMBODIMENT

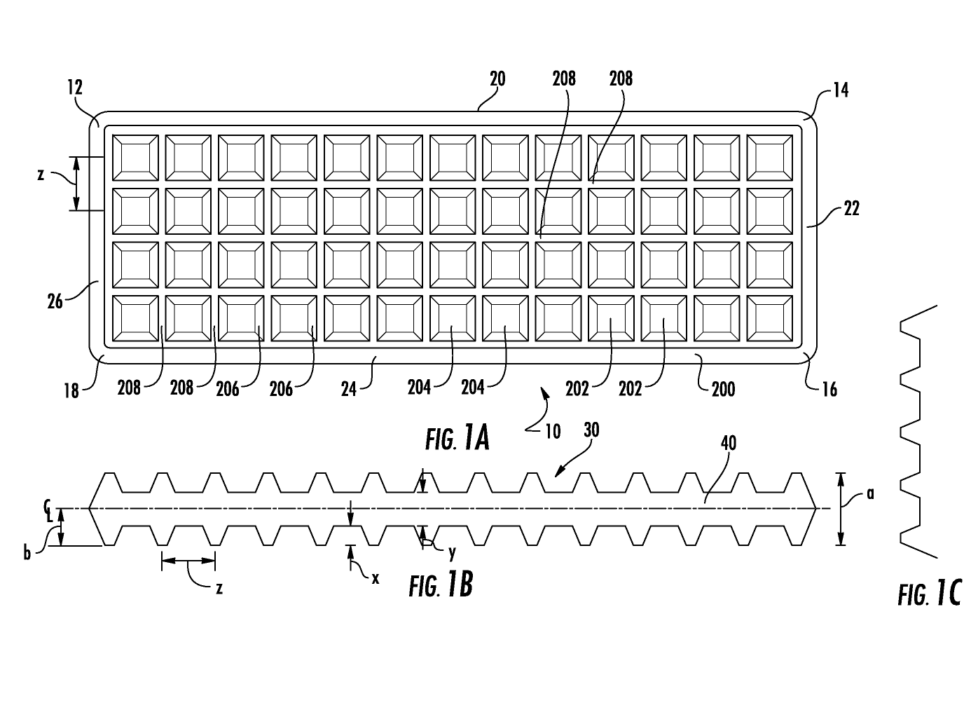

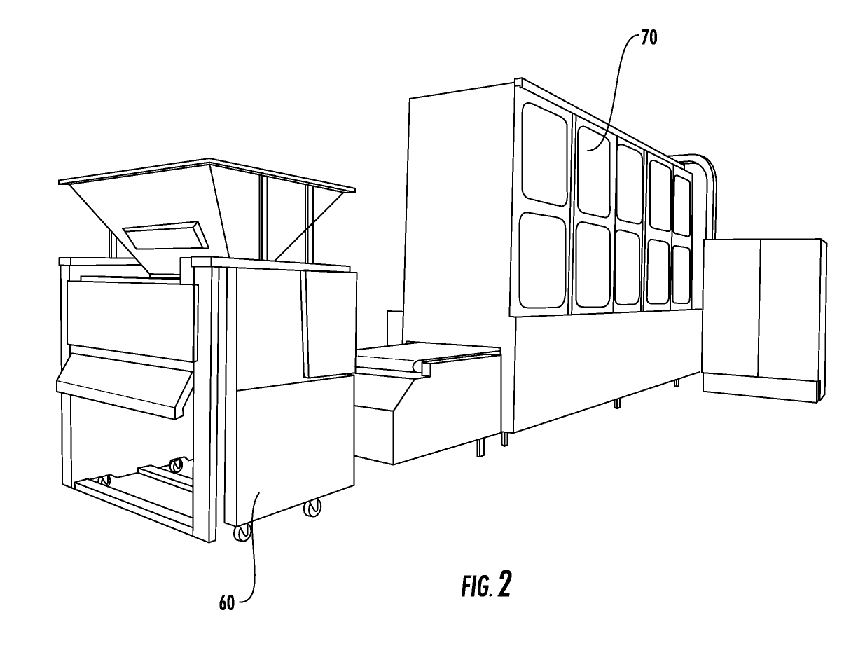

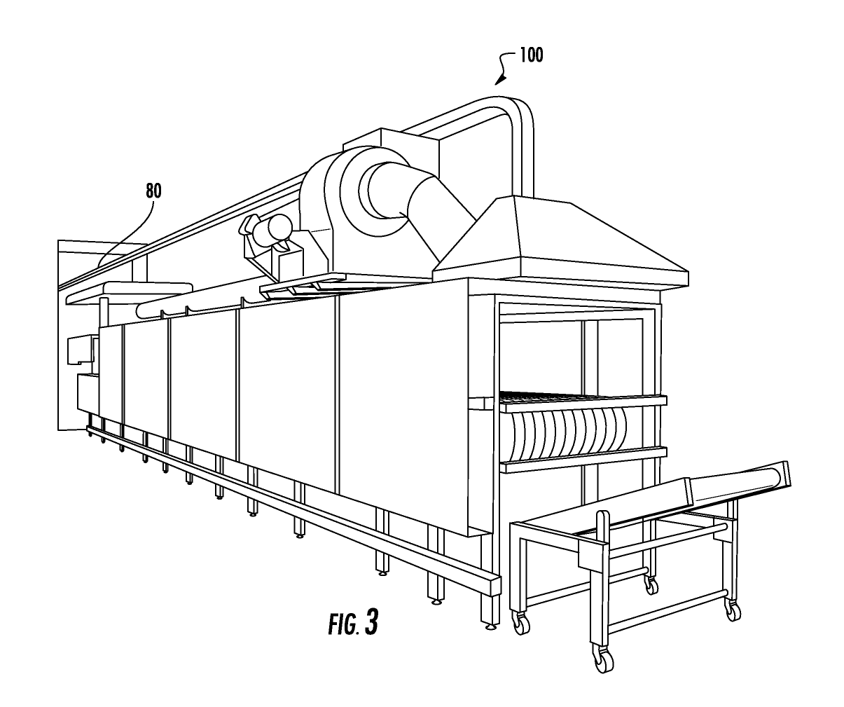

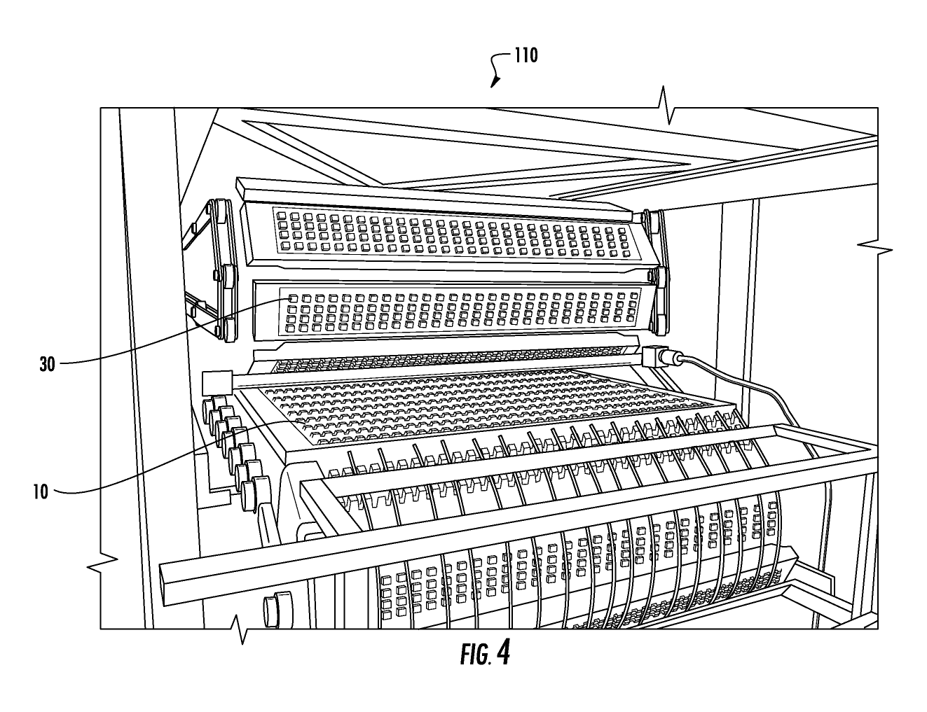

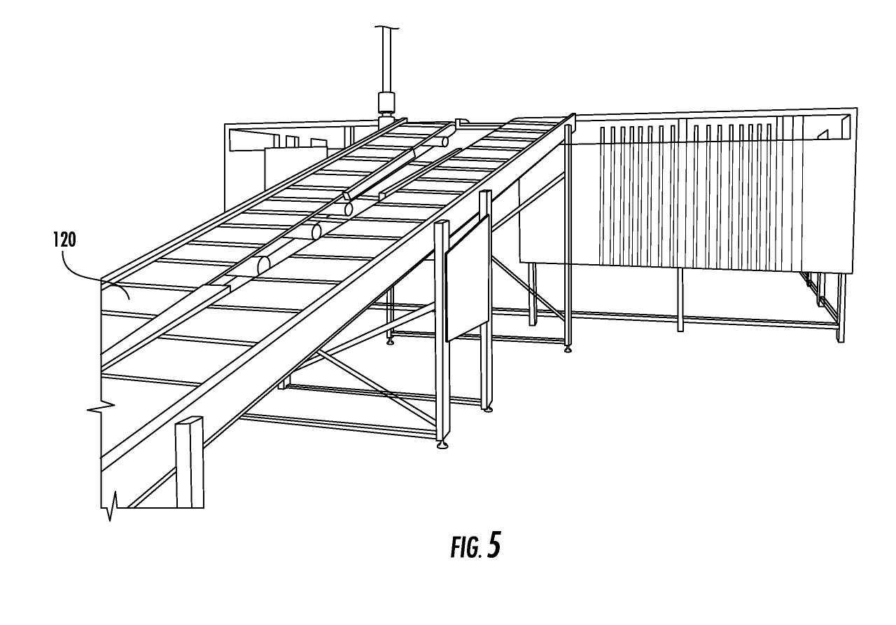

As best seen in the Figures, the present invention relates specifically to a set of waffle irons which are intended to be installed into a commercially available, conventional waffle oven and a component of a waffle producing plant. FIGS. 1a-1c show the specifics of the waffle irons, a pair, preferably, which are substantially identical and which overly one another as the conveyor of the upper waffle iron passes through the waffle oven, on top of the lower set of waffle irons. A single waffle iron can be manufactured and installed into the top layer of the waffle oven 100 and the same waffle iron used for the bottom layer of waffle irons in a waffle oven 100. A waffle iron 10, in the preferred embodiment, is basically rectangular and has curved corners 12, 14, 16 and 18, connecting longitudinal side 20 to short side 22 and opposed longitudinal side 24 to opposed short side 26. As can be seen, short side 22 is also connected to longitudinal side 24 and short side 26 is similarly connected to longitudinal side 20 (to complete the perimeter of the basic rectangular shape of the waffle irons 10). A supporting rim 200 is provided to facilitate the assembly of the waffle irons 10 to the waffle oven 100. A set of waffle irons 10 and 30 (see FIGS. 1a and 1b), when superimposed one above the other, as would appear when the same are properly installed into a waffle oven 100, define an interior chamber between them into which the dough/batter for making a waffle W is cooked/baked by passing through the waffle oven 100. Of course, a single set of opposed waffle irons 10 and 30 can be provided to a home-style, single, waffle making device or, as intended by the preferred embodiment, the entire upper conveyor of the waffle oven 100 can have a set of upper waffle irons 30 and the entire lower conveyor of the waffle oven 100 can have an identical set of lower waffle irons 10. The waffle irons 10 and 30 superimpose one over the other as the conveyors of upper and lower waffle irons pass down and through the waffle oven 100 and then separate at the distal end of the machine, as shown in FIG. 6, the waffle irons 10 and 30 then progressing back to the proximal end of the machine for creating a new set of waffle products W.

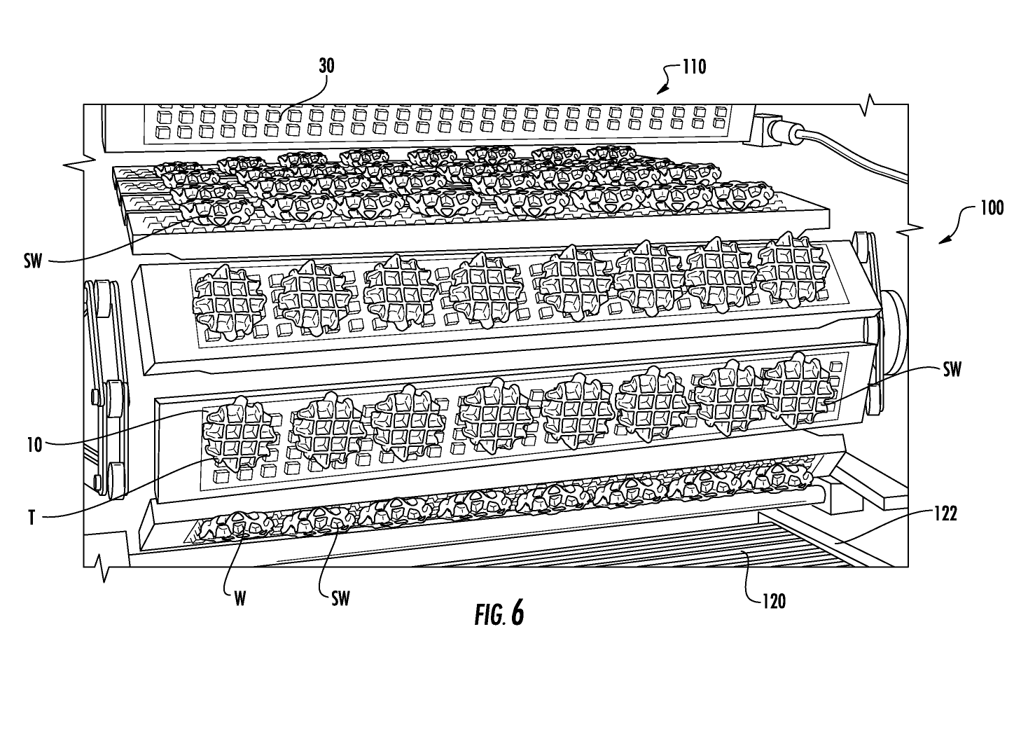

FIG. 2 shows the dough divider 60 and the proofing chamber 70 of the conventional, waffle making, high capacity production line, showing machinery and equipment ordinarily useful in such operations and, yet, forms no part of the present invention as the divider and proofing mechanisms are conventional, all in the making of the raw batter/dough, on its way to becoming ready for making into waffles. Of course, the ingredients for making waffles (the recipe) are well known and the recipe contains or may contain a variety of baking-like ingredients, Belgium waffle ingredients, flavorings, preservatives, yeast, extenders, etc. That, too, is not a component of the present invention. Nevertheless, the ingredients are properly mixed, kneaded as required, and pass through the dough/batter divider 60 on the way to the proofing chamber 70. From there, after proofing therein, the dough/batter is passed into the hopper 80 of the waffle oven 100. Waffle oven 100 is quite long and provides a length of heated conveyors of the waffle irons 10 and 30 so that raw dough/batter provided between the waffle irons 10 and 30 on one end, i.e., within the chamber 40 between the waffle irons, will become a baked waffle W as the same reaches the distal end 110 of the oven 100. As expected with these conventional and commercial waffle making ovens, the waffle W, when reaching the distal end 110 of the waffle oven 100 will rest upon the lower waffle iron 10 (see FIG. 6), with the distal end of the conveyor of the upper waffle irons 30 separating therefrom. Then, as the lower waffle iron 10 continues on its conveyor belt-like path, below the waffle oven and back to the proximal end of the waffle oven (similarly the upper waffle irons continue back to the proximal end of the waffle oven 100 by passing on top of the waffle oven), the baked/formed waffle products W will be flipped out, by gravity and pneumatic air assist, onto a set of cooling conveyors 120 (See FIGS. 5 and 6). The distal end 110 of waffle oven 100 with a set of waffles W located on the lower waffle irons 10, i.e., after the upper waffle irons 30 have separated therefrom (see the top of FIG. 6) are about to drop onto the cooling conveyors 120, as is best seen in FIG. 6. FIG. 6 shows the waffles W about to fall or drop onto the proximal end 122 of the cooling conveyor 120.

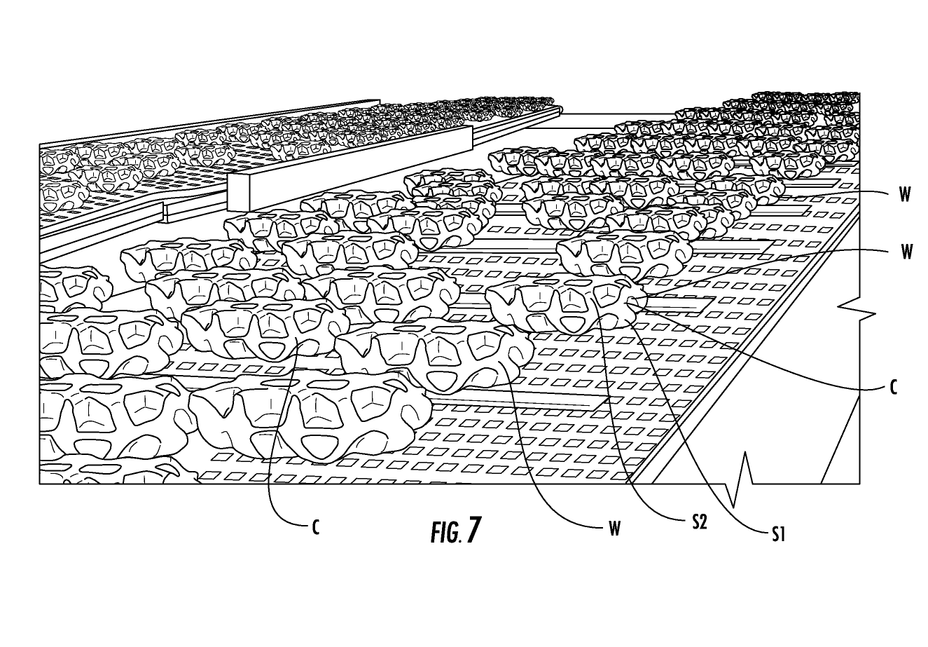

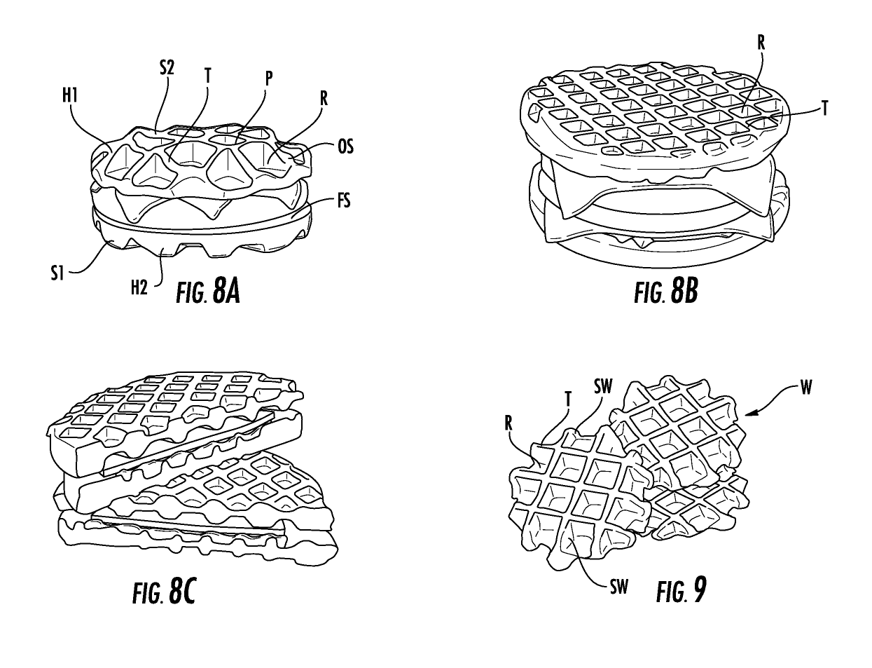

FIG. 7 shows the waffles W, as they are conveyed from the proximal end 122 of the cooling conveyors 120. As can be seen, each waffle W is formed with a waffle pattern P (See FIGS. 7 and 8a) on both sides S1 and S2. The waffles W are also provided, a consequence of the use of the lower and upper waffle irons 10 and 30, respectively, with a large center C. The waffles have, of course, a pattern P of deep square- (any shape can be used) shaped recesses R, separated by upwardly and outwardly sloped walls SW, defining tops T on both sides S1 and S2. The center C (See FIG. 7) can be sliced by a conventional, commercially available bread or bagel cutter to produce two matched halves H1 and H2 each of which is comprised of a patterned outside surface OS and a flat opposed surface FS. Together, the two matched halves H1 and H2 (see FIG. 8a) can be used for creating a sandwich as seen in FIGS. 8a. FIG. 9 shows small or snack size versions of the waffles W before they are sliced as those end products are also edible. FIGS. 8b and 8c show sandwiches formed by two waffles W surrounding other food products (eggs, bacon or ham, cheese) wherein the waffles W are not sliced across their centers C.

The slicing of the waffles W, after suitable cooling, can be done by either standing the waffles on their ends/edges and causing the knife blade to pass vertically through the center C of the waffles to create the opposed, matching waffle halves H1 and H2 or, alternatively, by having a horizontal knife blade pass through the centers C, as the waffles W are on the conveyor belt with one side Si supported upon the conveyor belt and the other side S2 facing upwardly.

After slicing, the waffles may be made into sandwiches or not, flash frozen, packaged in cellophane, boxed, placed in master boxes, then on pallets and transported. Consumers, whether commercial or home users, buy the waffles W and then, when desired for use, reheat the same, either by first removing from the cellophane, by slicing an opening in the cellophane to allow for the exhaust of heat/moisture, or by removing the same first from the cellophane wrapper and placing the same into a microwave or other oven/toaster.

When two identical waffle irons 10 are superimposed one over the other, a chamber 40 (FIG. 1 helps to visualize this) is formed between the upper waffle iron 30 and the lower waffle iron 10. The chamber is intended to be fully or partially filled with waffle batter or dough. This can be accomplished by pouring the suitable amount of the mixed batter or dough onto the bottom waffle iron and then the top waffle iron is carefully laid over the bottom waffle iron, in the conveyor belt system of the waffle oven 100 or, if an individual waffle maker is employed, by closing one waffle iron over the other after the dough/batter is poured onto the bottom waffle iron. As can be appreciated, the chamber 40 is the “negative” for the “positive” waffle W to be formed between the waffle irons 10 and 30.

The waffle irons each have a rim 200 which facilitate the installation of the same into the waffle oven 100. In the preferred and illustrated embodiment shown in FIG. 1a, the waffle irons 10 are covered with a pattern of adjacent recessed squares 202, each of which is formed by a recessed bottom 204 and upwardly sloped (from the recessed bottoms) side walls 206. The distance separating adjacent recessed squares 202 are filled in by flat top walls 208. So that the same waffle iron 10 can be used for both the top and bottom of the conveyor system employed in commercial waffle making food production, the other side of the waffle iron is a mirror image of the first side shown in FIG. 1a. This can be seen in FIG. 1b. Thus, the waffle iron manufactured consistent with the present invention has two sides, each of which has a pattern of separated square recesses 202, each with square bottom surfaces 204, each with upwardly and outwardly sloped walls 206, which terminate and connect to adjacent flat tops 208 of adjacent square recesses 202. Thus, the waffle irons so made can be secured in the waffle oven 100 either on the top conveyor or the bottom conveyor and produce a set of waffles W, with square recesses R, upwardly (from the flat bottom of the square recesses) sloped walls SW and connecting flat tops T.

According to the present invention, the recesses, denoted “x,” have been designed to be precisely 9 mm of depth. The thickness of the center C between the bottom of the square recess on one side of a waffle W and the opposed bottom surface on the other side of the same waffle W, denoted “y,” is about 15 mm. The lateral distance between a pair of adjacent flat tops T, denoted “z,” is preferably about 24 mm (center to center) and the overall thickness of the waffle, formed by the waffle irons 10, denoted “a,” is about 33 mm. The thickness, then, of the waffle iron 10 is also about 33 mm so that the height from longitudinal center line CL of the waffle iron 10 to the top of the set of flat tops T in between the recessed squares, denoted “b,” is about 16.5 mm. By precisely adjusting these dimensions, the inventor has been able to maintain an overall weight of the end product at about 55 grams, and a waffle W is produced with a thickened center C which is capable of being sliced by a commercially available, bakery-like slicing machine, all without crumbling. This slicing will result in a set of matching waffle halves H1 and H2 each of which comprises a waffle pattern P on the outside surface OS and an opposed flat surface FS—perfect for use in a new sandwich food product or edible by itself. The thickness of the center C of the waffle produced by the waffle irons set forth herein is most preferably between about 11 to 15 mm yet preferably in the range of about 10 to 20 mm. The thickness of portions of the waffle W is about 2 mm (bottom of square recess to bottom of opposed square recess). The present invention has reduced the depth of the squares from a conventional waffle iron and increased the central thickness or center C of the waffle W, to produce a new product, still maintaining about 55 grams in overall weight. The invention thus provides a sliceable (by commercial bread and bagel slicer machinery and without crumbling) food product comprising a matching set of waffle halves H1 and H2 each of which has a patterned waffle outer surface OS and an opposed flat surface FS.

The new set of waffle irons, assembled on a waffle oven, are believed to have excellent throughput of about 3000 units her hour and it is believed likely that a commercial production establishment can achieve rates of 9000 to 20,000 units per hour, as the time for baking a set of waffles between opposed waffle irons is about 2 minutes and 45 seconds.

While the present invention has been described herein with reference to the preferred embodiment, many modifications and variations are possible in light of the above teachings. It is therefore to be understood that in the scope of the appended claims the invention may be practiced otherwise than as specifically described.

What is claimed is:

1. A waffle iron comprising a patterned set of recesses which when filled with batter and heated will produce a waffle product wherein the center thickness between the bottoms of said recesses in a finished waffle is the range of about 10 to 20 mm.

2. A waffle iron as claimed in claim 1 wherein the center thickness between the bottoms of said recesses in a finished waffle is in the range of about 11 to 15 mm.

3. A waffle iron as claimed in claim 1 wherein said waffle iron comprises two outwardly facing mirror surfaces so that either can be used for the top or bottom conveyors in a waffle oven.

4. A waffle iron as claimed in claim 1 wherein the depth of said recesses is about 9 mm.

5. A waffle iron as claimed in claim 1 wherein the distance between adjacent flat tops of the separators formed between said recesses is about 24 mm.

6. A waffle iron as claimed in claim 1 wherein the overall thickness of said waffle iron is about 33 mm and said waffle iron comprises two outwardly facing set of patterned recesses.

7. A waffle iron as claimed in claim 1 wherein said patterned set of recesses are separated squares and the outside perimeter of said waffle product formed thereby is either a square or a circular shape.

8. A waffle produced by use of a waffle iron as claimed in claim 1 by use of the same in a commercial waffle oven.

9. A waffle produced as claimed in claim 8 wherein the thickness of the center is about 10 to 20 mm thick and the thickness of the waffle, measured between opposed bottoms of said recesses is only in the range of about 2 mm.

10. A waffle as claimed in claim 8 wherein the thickness of the center is in the range of about 11 to 15 mm thick.

11. A waffle as claimed in claim 8 further sliced in half through its center to produce a matched set of waffle products each of which has a patterned face and an opposed, flat face.

12. A waffle as claimed in claim 8 wherein the outside perimeter of the same defines a circle or a square.

13. A method of making a waffle-like product comprising the steps of:
a) creating waffle dough;
b) providing a set of opposed and identical waffle irons having reduced recesses from conventional thickness of the same;
c) heating said waffle irons and said waffle dough to form a waffle; and
d) slicing said waffle to form a matched set of waffle products each of which comprises a patterned waffle face and an opposed flat face.

14. A method as claimed in claim 13 wherein said slicing is done on a commercially available bread or bagel slicer.

15. A method as claimed in claim 13 wherein said waffle irons are configured to produce a waffle as set forth in step c) of a thickness in the range of about 10-20 mm.

16. A method as claimed in claim 13 wherein said reduced recesses are in the range of about 9-11 mm of depth.

17. A method as claimed in claim 13 wherein the thickness of said waffle product, measured between opposed surfaces of said recesses, is about 2 mm.

18. A method as claimed in claim 13 wherein said waffle irons are configured to produce a waffle as set forth in step c) of a center thickness in the range of about 11-15 mm

19. A waffle product comprising a matched set of halves wherein each half comprises a patterned side and an opposed flat side.

20. A waffle product as claimed in claim 18 wherein the thickness of each of said halves is about 16.5 mm.

21. A waffle product as claimed in claim 18 wherein the same is formed from a single waffle having a central thickness of about 15 mm.
